(19) United States
(12) Patent Application Publication
(10) Pub. No.: US 2019/0231112 A1
(43) Pub. Date: Aug. 1, 2019

(54) Campfire Steam Cooker and Method of Using the Same

(71) Applicants: Russell Nieland, Little Chute, WI (US); Sheryl Nieland, Little Chute, WI (US)

(72) Inventors: Russell Nieland, Little Chute, WI (US); Sheryl Nieland, Little Chute, WI (US)

(21) Appl. No.: 15/883,517

(22) Filed: Jan. 30, 2018

(51) Int. Cl. A47J 27/04; A47J 33/00

(52) U.S. Cl. CPC A47J 27/04; A47J 2027/043; A47J 33/00

(57) ABSTRACT

A campfire steam cooker configured for use with a campfire or other open fire source, comprises a container having a cavity, a heat-transferring lower surface, a lid, at least one center unit having at least one pan supported by at least one arm, wherein the center unit is configured to mate within the cavity, a crossbar support system configured to span a campfire, and a hook on the outside of the container configured to suspend the container over the campfire by hanging it on the crossbar. A method of using the same comprises inserting water into the base, placing an item of food on the pan, placing the center unit within the container, hanging the container on the crossbar, lighting a campfire, and allowing the food to steam.

### CROSS-REFERENCE TO RELATED APPLICATION

This application claims priority to U.S. Provisional Application No. 62/452,869 filed on Jan. 31, 2017 the disclosure of which, including any materials incorporated by reference therein, is incorporated herein by reference in its entirety.

### TECHNICAL FIELD

The present invention relates generally to a cooking apparatus. More particularly, the present invention concerns a portable food steamer suitable for use over a campfire and a method of using the same.

### BACKGROUND

Many outdoors-persons enjoy a home-cooked meal over an outdoor fire. Such persons often find something comforting in the hissing and crackling bright lights, the laughter of family and friends, and the smoky, flavorful food. Modern gas-burning camp stoves or specialized electric cookware items may simplify the job in some ways, but many persons prefer the taste of a meal prepared over a campfire. Campfire cooking also allows a wider variety of options than a stove, like preparing an entire roast.

There are several methods of outdoor cooking known to the art including, boiling, grilling, frying and even baking. Many campers prefer the boiling water method simply because it is the fastest. However, others prefer a more involved and higher quality meal provided by steaming food over a campfire.

Some steamers known in the art, such as the disclosure of U.S. Pat. No. 315,713, incorporated by reference in its entirety herein, do provide for a steaming apparatus that can be moved from one place to another, but disclosures such as these fail to provide the ability to quickly and efficiently steam food over a campfire.

Another example may be seen with respect to U.S. Pat. No. 9,247,842, incorporated by reference in its entirety herein, which generally discloses a multi-tiered steamer. While this disclosure does provide for an advanced steamer, it fails to provide for a steamer configured for use with a campfire.

Yet another example may be seen with respect to the disclosure of U.S. Pat. No. 8,893,704, incorporated by reference in its entirety herein, which generally discloses a modular grill that, in some embodiments, can expand and provide for open-flame cooking. While this disclosure and others like it provide for an open-flame cooking experience, they tend to be bulky, complicated, and fail to be configured for use with a campfire.

Therefore, a need exists for a unique and more effective campfire steam cooker and method of use for using the same.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a lid, pan, or grill, are herein meant to include or encompass all equivalents for such elements. For example, in addition to a “lid”, any covering element is also contemplated by the present invention. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention relates to an outdoor campfire steamer and method of using the same that overcomes the deficiencies of the prior art. The general purpose of the present invention, which will be described subsequently in greater detail, is to enable a user to steam food over a campfire safely and easily.

The features of the invention which are believed to be novel are particularly pointed out and distinctly claimed in the concluding portion of the specification. By way of non-limiting example, the present invention provides a novel solution for steaming food over an open flame. These and other features, aspects, and advantages of the present invention will become better understood with reference to the following drawings and detailed description.

In some embodiments, a campfire steam cooker and method of using the same comprises a plethora of interlocking pans, such as for example three, that provide for a bottom element, one or more middle elements, and a top element. It is contemplated that in certain embodiments the bottom element may comprise a solid, flat element adapted for use in retaining and transmitting heat, for example heat generated by a campfire. In other embodiments, the bottom element may be perforated, contoured, or otherwise configured to trap and transmit heat in different or more efficient ways than simply a flat surface. The one or more middle elements may provide for a perforated surface portion adapted for use in retaining food during steaming or steam cooking. The perforated design within the surface portion may in some embodiments comprise a grill, a flat pan with circular holes, or other suitable design that provides for the passage of steam through the present invention. The top element may comprise a lid with a handle on top. In other embodiments the middle element may contain a configuration wherein a small cylinder suitable for receiving a standardized can of food rests upon one or more additional elements, such as but not limited to a grill or grate.

Whereas in some embodiments, a series of stacking pans is contemplated, in other embodiments the present invention may comprise a series of interlocking cylindrical elements. Such embodiments may comprise a pitcher-shaped element with hooks to secure it to another device or object, and a slightly smaller pitcher-shaped element designed to be received into the pitcher shaped outer element. Such embodiments may also provide for a lid and steaming functionality.

It is contemplated that in certain embodiments of a method for using a campfire steam cooker, a user may insert water into the bottom element, then set an interlocking middle portion over the bottom portion, put food on the middle portion, and then put the top portion on to create a seal. The user may then put the unit over a heat source, such as a campfire, that will boil the water, creating steam that then travels up through the perforated portions of the middle portion, and is trapped by the lid, thereby steaming the food.

It is also contemplated that, in certain embodiments, the present invention may be configured to interlock with campfire assemblies, such as a Campfire Supreme. In such embodiments, the top, middle, and bottom elements, which create an interlocking sealed unit, may further interlock with or otherwise be configured to align with a campfire or other heat source, thereby maximizing the convenience and effectiveness of the present invention. For example, the Campfire Supreme may provide for a cylindrical center element wherein charcoal or wood may be burned to create a campfire. In such a combination, the present invention may be designed to interlock with, rest on, or otherwise align with the cylindrical center element, thereby maximizing the convenience and effectiveness of the present invention.

In other embodiments of the campfire steam cooker, the method of using a campfire steam cooker, or both, the present invention may be adapted for use with more traditional fire pits, wherein the present invention may provide for a crossbar support system that straddles the fire. A bolt-on support bar may hook onto the cross bar. The crossbar system may be placed over an unlit fire pit at a height that supports the one or more steamers. Once in place and the campfire is lit, each steamer may be positioned directly over the campfire. Water may then be poured inside the outer pan and added throughout the process, creating steam. The fire may then burn for about an hour, thereby partially or entirely cooking the food inside. In some embodiments, a special handle may be provided that a user may use to remove the cover and check the food. The handle, or a different handle, may also be used to lift the steamer out of the fire, ideally without injury.

The unique features of the present invention may provide the following benefits for one or more users: it may improve a user's camping lifestyle; it may allow consumers to steam whole chickens, roasts and vegetables over a campfire; it may provide foods with great outdoor flavor; and it may contain or provide extra pans in which to quickly heat up previously prepared food.

### BRIEF DESCRIPTION OF THE DRAWINGS

These and other features, aspects and advantages of the present invention will become better understood with regard to the following description, appended claims, and accompanying figures where:

FIG. 1 shows a top perspective view of a campfire steam cooker in accordance with one embodiment of the invention.

FIG. 2 shows a top perspective view of an opened campfire steam cooker in accordance with one embodiment of the invention.

FIG. 3 shows an internal perspective view of a campfire steam cooker in accordance with one embodiment of the invention.

FIG. 4 shows a side view of a campfire steam cooker in accordance with one embodiment of the invention.

FIG. 5 illustrates a method of using a campfire steam cooker in accordance with an embodiment of the invention.

### DETAILED DESCRIPTION

The present invention overcomes the limitations of the prior art by providing a new and more effective campfire steamer and method of using the same.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well known features, elements or techniques may not be shown in detail in order not to obscure the embodiments.

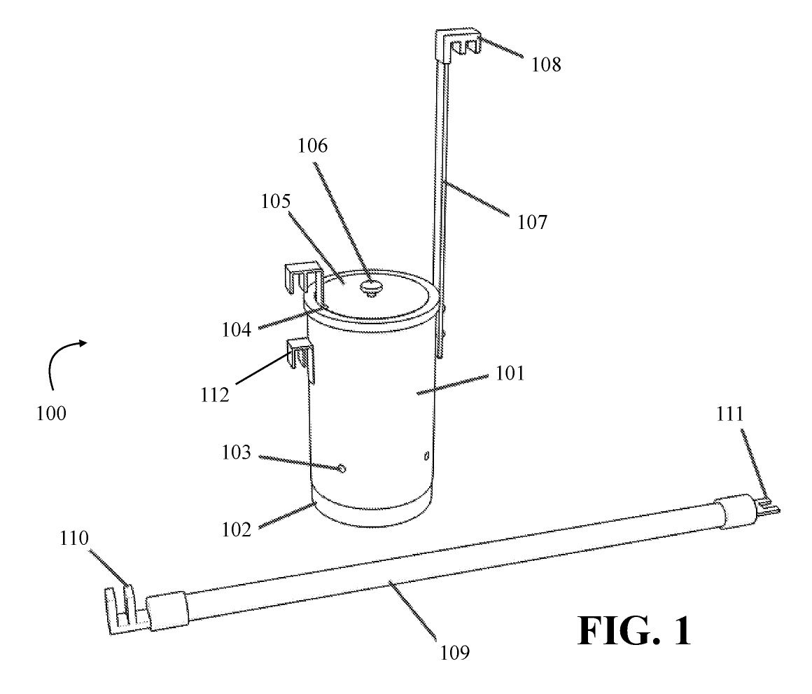

Turning attention to FIG. 1, a top perspective view of a campfire steam cooker in accordance with one embodiment of the invention is shown. In the embodiment depicted, a viewer may perceive campfire steam cooker 100, container 101, ring 102, holes 103, notch 104, lid cover 105, knob 106, bar 107, hook support for crossbar 108, pole 109, pole hook 110, prong 111, and container hook 112. The present invention may also provide for one or more crossbars and crossbar support systems, neither of which is shown in FIG. 1.

Container 101 may of any construction or material known in the art, but in some embodiments may be metal or a heat-resistant plastic. Although depicted in FIG. 1 as cylindrical, container 101 may be of any shape known in the art, such as a cube or a brick-shape. In some embodiments, more than one container 101 may be provided. In some such embodiments, the two or more (not shown) containers 101 may be connected by one or more tubes (also not shown), such as may be configured to conduct steam. Container 101 may also be of any size known in the art, such as smaller, larger, or of a different size than shown in FIG. 1. Container 101 may also provide for one or more legs or other bottom support (not shown) connected to the base of container 101.

Additionally, an outside pan (not shown) may in some embodiments be provided that may be shaped to accept the lower portion of container 101. In embodiments with the outside pan, container 101 may rest in the outside pan. The outside pan may itself be configured to transfer heat, and in some embodiments also to receive water for boiling. In those embodiments, the bottom of container 101 may be configured to receive the steam from the outside pan, such as by way of illustration and not limitation, perforations in the base of container 101. In some embodiments, the outside pan may be metal, and may be of the same metal as container 101.

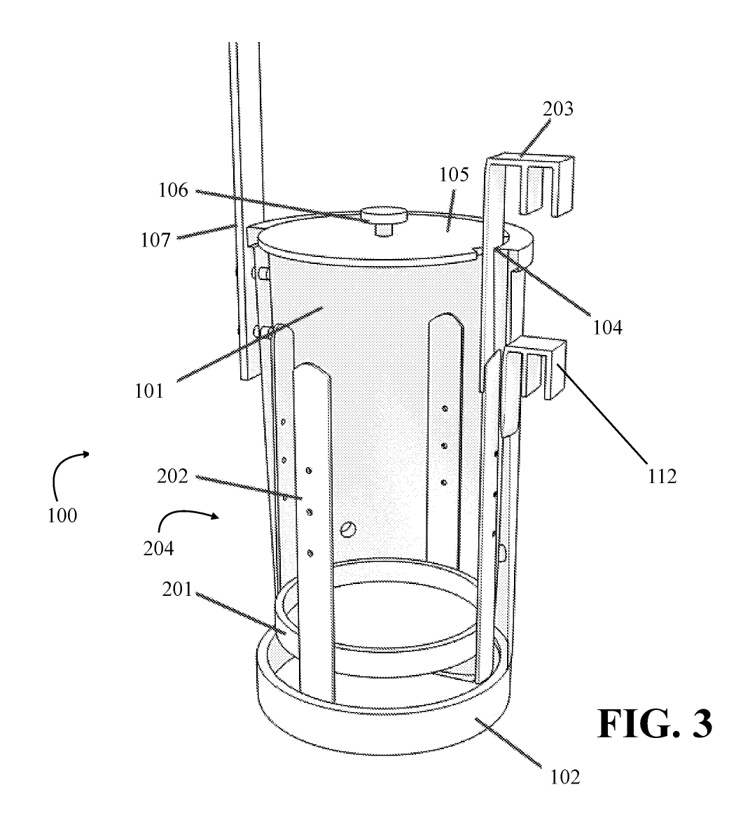

Ring 102 may in some embodiments serve as a base or base plate into which a user may pour water for steaming. As can be seen more easily in FIG. 3, the center area of ring 102 configured to receive water for steaming may comprise most of ring 102. The top of ring 102 may be configured to face up into the center cavity of container 101, thereby allowing steam from heated water within ring 102 to steam the inside of container 101. In some embodiments wherein ring 102 comprises the base of container 101, one or more legs or other bottoms support elements may be fixedly connected to ring 102.

Hook support for crossbar 108 may be configured to allow a user to hang container 101 over a campfire by hanging it on a crossbar (not shown). The crossbar may be connected to one or more crossbar supports (not shown). The crossbar supports may be set up next to the campfire and may allow a user to rest the crossbar across the crossbar supports, thereby allowing the crossbar to span the campfire and provide a surface upon which a user may hang container 101 by means of hook support for crossbar 108. In some embodiments, container hook 112 may serve some or all of the function of hook support for crossbar 108.

Together, pole 109, pole hook 110, and prong 111 may in some embodiments comprise a handle or other element configured to enable a user to move around one or more elements of campfire steam cooker 100 without getting burnt by a lit campfire. For example, a user may extend pole 109 towards container 101 and use prong 111 to lift lid cover 105 by means of exerting upward force on knob 106. Or, a user may extend pole 109 towards container 101 and use pole hook 110 to engage hook support for crossbar 108 or container hook 112.

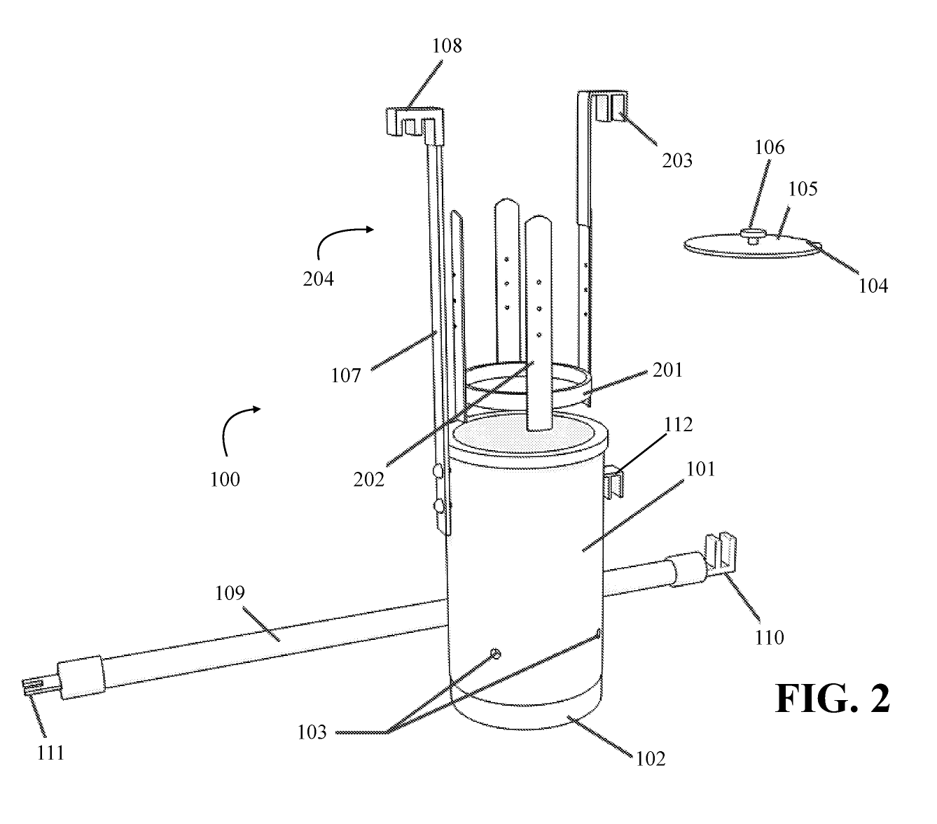

With respect to FIG. 2, a top perspective view of an opened campfire steam cooker in accordance with one embodiment of the invention is shown. In the embodiment depicted, a viewer may perceive pan 201, arms 202, arm hook 203 and center unit 204, as well as campfire steam cooker 100, container 101, ring 102, holes 103, notch 104, lid cover 105, knob 106, bar 107, hook support for crossbar 108, pole 109, pole hook 110, prong 111, and container hook 112.

FIG. 2 provides a viewer with visual information related to the relationship between center unit 204 and the center cavity of container 101 (not separately labeled). In the embodiment depicted, pan 201 is shown as a disc with more than one arm 202 connected orthogonally to pan 201, and an arm hook 203 is shown connected to an arm 202. As may be imagined based on FIG. 2, a user may place food on pan 201 and use arm hook 203 to lower center unit 204 into the cavity of container 101 where it can be steamed.

A viewer will note that in some embodiments, arms 203 may extend downward past pan 201. In some embodiments, this may create a distance between pan 201 and ring 102 that may enable better steaming.

Moving to FIG. 3, an internal perspective view of a campfire steam cooker in accordance with one embodiment of the invention is shown. In the embodiment depicted, a viewer may perceive container 101, ring 102, notch 104, lid cover 105, knob 106, bar 107, container hook 112, pan 201, arms 202, arm hook 203 and center unit 204.

FIG. 3 generally shows a zoomed-in view of center unit 204, and its spatial or functional relationships to the other elements of campfire steam cooker 100. For example, the size and shape of ring 102 and pan 201 are more clearly seen in FIG. 3. Pan 201 may be configured to as a disc of slightly or greatly smaller radius than ring 102. Any of container 101, ring 102, and pan 201 could be of different sizes or shapes as well. For example, container 101, ring 102, and pan 201 could be square-shaped.

A viewer of FIG. 3 will also note that in some embodiments, pan 201 could be of different size, shape, or configurations. Pan 201 may be of any material known in the art, such as metal, elastomer, or plastic, or a combination of any material known in the art. Pan 201 may provide for one or more perforations as well. For example, in some embodiments pan 201 could provide for one or more holes or could be systematically perforated in a grill-shape. In some embodiments, multiple pans 201 may be retained within arms 203. In some embodiments, center unit 204 may provide for one, two, three or more arms 203, and any number of pans 201.

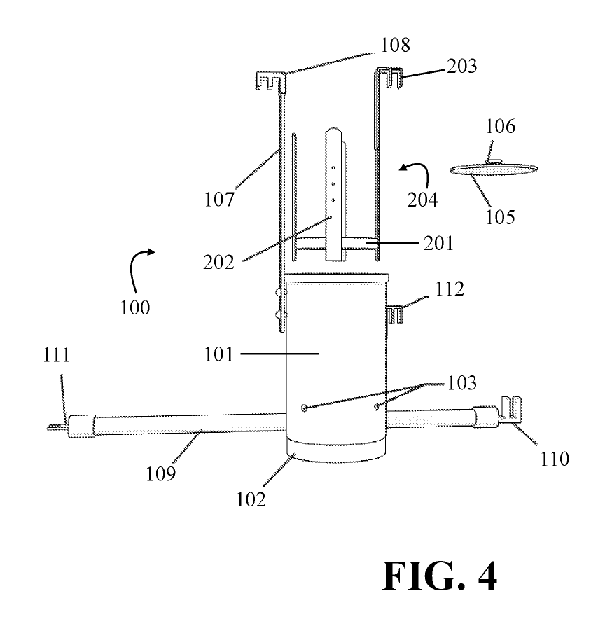

With respect to FIG. 4, a side view of a campfire steam cooker in accordance with one embodiment of the invention is shown. In the embodiment depicted, a viewer may perceive campfire steam cooker 100, container 101, ring 102, holes 103, lid cover 105, knob 106, bar 107, hook support for crossbar 108, pole 109, pole hook 110, prong 111, container hook 112, pan 201, arms 202, arm hook 203 and center unit 204.

It should be noted that the various elements of campfire steam cooker 100 may be of any size or configuration known in the art. For example, although center unit 204 is shown in FIG. 4 as being a close fit with the cavity of container 101, in some embodiments center unit 204 may occupy less room in the cavity of container 101. In some embodiments, multiple center units 204 of the same or different shape as shown in FIG. 4 may be configured to fit within one container 101. In some embodiments, multiple container 101 may be provided of any shape, including two or more connected containers 101.

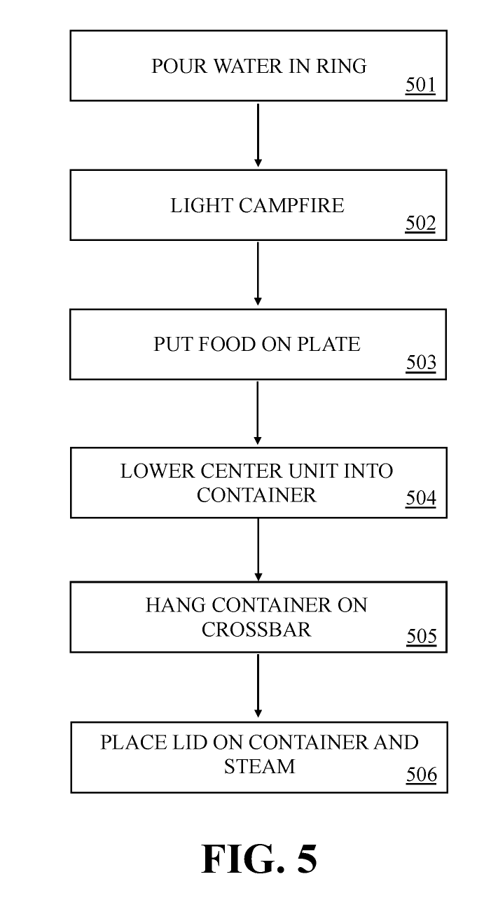

Turning attention to FIG. 5, a viewer may perceive an illustrative method of using a campfire steam cooker in accordance with an embodiment of the present invention. In the illustration provided in FIG. 5, a user first puts water in the ring 501. Then, a user lights a campfire 502. Following that, a user may place food on the plate 503. A user may then lower the center element into the container 504. The user may then hang the container on a crossbar 505. Lastly, a user may place a lid on the container 506 and allow the campfire to heat the water into steam, which fills the container, steaming the food on the plate.

In some embodiments, steps 501 and 502 may be done in reverse order. That is, a user may first light the campfire 502, then put water in the ring 501. In some embodiments as well, wherein the campfire is of a particularly even construction, a user may omit step 505 and not hang the container on a crossbar. Additionally, should a user so desire, a user may omit step 506 and not put a lid on the container while the container is steaming the food. In some embodiments, additional steps may be included such as but not limited to, in embodiments with more than one place, putting food on the more than one plate in a sequence or hanging more than one container on the same crossbar.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention has been disclosed in connection with a number of embodiments shown and described in detail, various modifications should be readily apparent to those of skill in the art.

What is claimed is:

1. A campfire steam cooker, comprising:
at least one container, comprising:
a) at least one side having a container exterior and a container interior;
b) a container cavity defined by the container interior, wherein the container cavity has an upper opening;
c) a base configured to transfer heat;
d) a lid having a lid upper surface and a lid lower surface, wherein the lid is configured to removably seal the upper opening; and
e) at least one notch disposed on the container interior at the upper opening;
at least one center unit configured to be received within the container cavity, the center unit comprising:
a) at least one pan configured to transfer heat;
b) at least one bar orthogonally disposed on the at least one pan; and
c) at least one hook disposed on the at least one bar, wherein the at least one hook is configured to fit within the at least one notch;
at least one crossbar support element;
at least one crossbar extending from the at least one crossbar support element, wherein the crossbar is configured to receive the at least one container hook;
a pole having a first pole end and a second pole end;
a pole hook disposed on the first pole end; and
a prong disposed on the second pole end.

2. The campfire steam cooker of claim 1, wherein the at least one container is cylindrical.

3. The campfire steam cooker of claim 1, wherein the at least one center unit is cylindrical.

4. The campfire steam cooker of claim 1, wherein the base is disc-shaped.

5. The campfire steam cooker of claim 1, wherein the at least one pan is perforated.

6. The campfire steam cooker of claim 1, further comprising two pans.

7. The campfire steam cooker of claim 1, further comprising three pans.

8. The campfire steam cooker of claim 1, further comprising a knob disposed on the lid upper surface.

9. The campfire steam cooker of claim 1, further comprising at least one container hook disposed on the container exterior.

10. The campfire steam cooker of claim 1, further comprising two cylindrical containers connected by at least one steam tube.

11. The campfire steam cooker of claim 1, wherein the at least one center unit is a first center unit and a second center unit, and wherein the container cavity is configured to receive the first center unit and the second center unit.

12. A method of use for a campfire steam cooker, the method comprising:
providing at least one container, comprising:
a) at least one side having a container exterior and a container interior;
b) a container cavity defined by the container interior, wherein the container cavity has an upper opening;
c) a base configured to transfer heat;
d) a lid having a lid upper surface and a lid lower surface, wherein the lid is configured to removably seal the upper opening;
e) at least one notch disposed on the container interior at the upper opening; and
f) at least one container hook disposed on the container exterior;
providing at least one center unit configured to be received within the container cavity, the center unit comprising:
a) at least one pan configured to transfer heat;
b) at least one bar orthogonally disposed on the at least one pan; and
c) at least one hook disposed on the at least one bar, wherein the at least one hook is configured to fit within the at least one notch;
providing at least one crossbar support element;
providing at least one crossbar extending from the at least one crossbar support element, wherein the crossbar is configured to receive the at least one container hook;
providing a pole having a first pole end and a second pole end, a pole hook disposed on the first pole end, and a prong disposed on the second pole end;
arranging the at least one crossbar support element and the at least one crossbar such that the at least one crossbar support element holds the at least one crossbar in position across at least one campfire site;
pouring water into the base;
placing food on the pan;
placing the at least one center unit into the container cavity;
suspending the at least one container over the campfire site by hanging the at least one container on the at least one crossbar via the at least one container hook;
placing the lid on the container so as to cover the container cavity;
lighting the campfire; and
allowing the food to steam.

13. The method of claim 12, wherein the at least one container is cylindrical.

14. The method of claim 12, wherein the at least one center unit is cylindrical.

15. The method of claim 12, wherein the base is disc-shaped.

16. The method of claim 12, wherein the at least one pan is perforated.

17. The method of claim 12, further comprising two pans.

18. The method of claim 12, further comprising three pans.

19. The method of claim 12, further comprising a knob disposed on the lid upper surface.

20. The method of claim 12, wherein the at least one center unit is a first center unit and a second center unit, and wherein the container cavity is configured to receive the first center unit and the second center unit.
